(19) United States
(12) Patent Application Publication
(10) Pub. No.: US 2009/0174467 A1
(43) Pub. Date: Jul. 9, 2009

(54) POWER SUPPLY CIRCUIT FOR THE WALL MOUNTED ELECTRONIC SWITCH

(75) Inventor: Jihn Kuk Kim, Seoul (KR)

Correspondence Address: THE RAFFERTY PATENT LAW FIRM, 1952 Gallows Road, Suite 200, Vienna, VA, 22182-3823, US

(73) Assignee: HAGA ELECTRONICS CO., LTD, Seoul (KR)

(21) Appl. No.: 12/295,865

(22) PCT Filed: May 2, 2007
(86) PCT No.: PCT/KR07/02143

§ 371 Date: Oct. 2, 2008

(30) Foreign Application Priority Data
May 19, 2006 (KR) 10-2006-0045075

(51) Int. Cl. G05F 1/10

(52) U.S. Cl. 327/538

(57) ABSTRACT

This is a disclosure of a power supply circuit for wall-mounted electronic switches. The disclosed invention is about a power supply circuit for driving circuit inside the wall-mounted electronic switches, which can supply sufficient current demanded by these switch circuits. Recently the functions of wall-mounted electronic switches are being diversified from lamp switching to security, watch, remote control, room temperature control, etc. and the amount of current required inside the switch circuits is increased up to tens of mA. This requires a competitive power supply circuit that can supply a high current. In addition, a space-saving characteristic is also required because the space of a wall-mounted switch is narrow. The invented power supply circuit for electronic switches saves space, supplies a high current, and enhances competitiveness in price and quality, and consequently it makes a considerable contribution to the competitiveness of wall-mounted electronic switches.

### TECHNICAL FIELDS

The present invention is “a power supply circuit for wall-mounted electronic switches” that enables the power supply for control circuit in wall-mounted electronic switches is realized space saving, high supply current, low cost, and high quality. Because an ordinary wall switch wire uses only one of the two AC power supply lines, which connect the objects like lamp on and off, as in FIG. 1, we used a separate transistor to drive out the current for internal circuitry of wall-mounted electronic switches as in FIG. 2. However, in case the load [Lamp] is under 20 W, current obtainable from the secondary side of transformer [T₁] is only several mA. In order to raise it to tens of mA, the size of transformer [T₁] should be very large and thus it was difficult to use the circuit as the power supply of switches that require high current. In addition, a conventional power supply circuit as in FIG. 2 was unstable in reliability because of its considerable variation of supply voltage due to the change of load [Lamp] and its use of big transformer cause big size and relatively higher cost.

### BACKGROUND TECHNOLOGY

Designed to solve these problems, the present invention purposes to provide a power supply circuit that can supply high power of DC 5V and over 30 mA stably through one line of wall switch wire under low load [Lamp] of 20 W.

### DISCLOSURE OF THE INVENTION

For this purpose, the characteristic of the invented “power supply circuit for wall-mounted electronic switches” is the inclusion of a step that uses a large part (30˜40%) of load current for driving the circuit when the load [Lamp] is on. Accordingly, using the invented “power supply circuit for wall-mounted electronic switches,” we can use a large part of load [Lamp] current as power for driving the circuit without a separate transformer for driving current out, and this simplifies the circuit, improves space utility, stabilizes the reliability of power supply, and contributes to price competitiveness.

The following is detailed explanation about desirable applications of the invented “power supply circuit for wall-mounted electronic switches” refer to attached drawings.

FIG. 1 is an application circuit example for wall-mounted mechanical switches. FIG. 2 is an application circuit example of a wall-mounted electronic switch using a conventional power supply circuit. In the application, because the voltage of power for driving the circuit is very low as 5V and 5 mA, the circuit is not applicable to multi-functional switches of 5V and over 30 mA that use even LCD backlight. The operating principal of this invention shall be explained refer to the representative circuit of this invention, FIG 3. In FIG. 3, the switch element that turns on and off the lamp [Lamp] is a triac [TRC₁], and on-off is controlled by a microcomputer(micom) [U₁] receiving switch input [SW₁] signal. Because the charged energy in capacitor C₂ is supplied to control micom [U₁] and LCD driving circuit block [2] through resistor [R₂], the circuit configuration of this invention is to charge as much current as possible to capacitor [C₂].

When the triac [TRC₁] is off, the second capacitor [C₂] is charged when the AC in terminal [IN] is higher than the out terminal [OUT], and the charging current path is as follows:

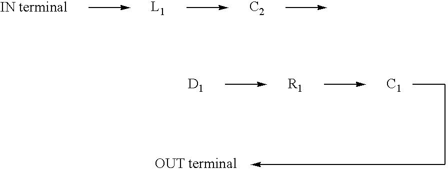

In this time, electric energy is charged to [C₁] also, and this electric energy is discharged during the next half-wave period [when the voltage of the out terminal is higher than the voltage of the in terminal and at that time the discharging current path of [C₁] is as follows:

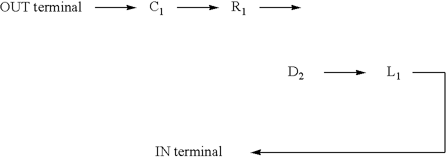

As a matter of fact, the electric energy is supplied to [C₂] only during the half-wave period. When the lamp switch element [TRC₁] is on, it is the same as a short circuit between the in terminal [IN] and the out terminal [OUT] above and as a result, current (or electric charge) cannot be supplied to the second capacitor [C₂] through the current path above. Thus, the first coil [L₁] is added between the in terminal [IN] and the triac [TRC₁], and the diode [D₃] is added between the ground point and in terminal [IN]. With this addition, when load [Lamp] is on, a large part of load current flows charging the second capacitor [C₂] and the remaining flows through the first coil [L₁]. When load is on, if the voltage of the out terminal [OUT] is higher than the voltage of the in terminal [IN], the second capacitor [C₂] is charged and at that time the charging current path is as follows.

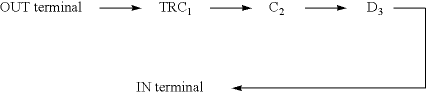

Where, if we assume that the lamp load current is I(t) and the current charging [C₂] is i(t), the current of L₁ becomes I(t)-i(t) and as a result, assuming that the capacitance of [C₂] is C and the inductance of [L₁] is L, charging is done with satisfying the equation below.

$$L \cdot \frac{d [ I ( t ) - i ( t ) ]}{d t} = 0.7 + \frac{1}{c} \cdot \int i ( t ) d t$$

As shown in the equation above, when load current [I(t)] is fixed, current i(t) for driving can be raised by increasing the inductance of L₁.

When the voltage of the in terminal is higher than the voltage of the out terminal, [C₂] is not charged and the current path of load current [I(t)] is as follows:

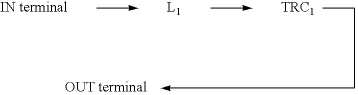

As a result, load current flows only through L₁.

In the application example of FIG. 3, the fourth (Zener) diode is to supply constant voltage, the fifth (Zener) diode is for protecting the withstand voltage of the triac [TRC₁], and the fifth resistor [R₅] and the fourth capacitor [C₄] are for protecting the triac [TRC₁] in turning on/off inductive load like a conventional fluorescent lamp using choke coil.

### BRIEF DESCRIPTION OF DRAWINGS

FIG. 1: Mechanical wall switch

FIG. 2: Drawing of an application circuit example of a wall-mounted electronic switch using conventional power supply circuit

FIG. 3: Drawing of an application circuit example of a wall-mounted electronic switch using the invented power supply circuit for wall-mounted electronic switches

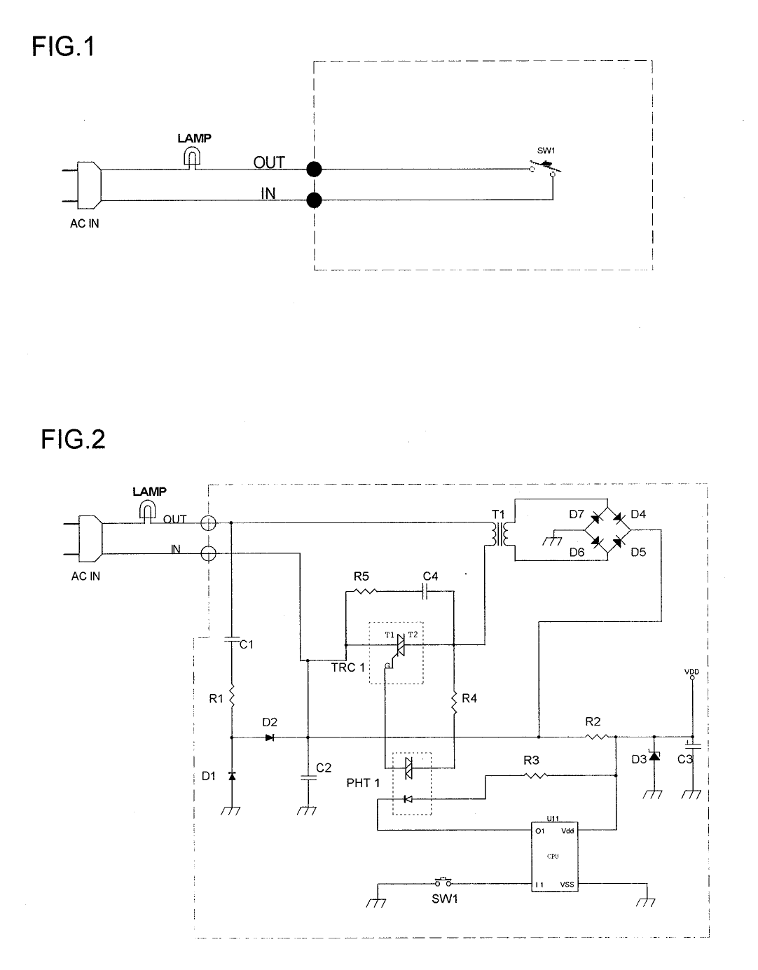

### DESCRIPTION ABOUT SYMBOLIC MARKS OF THE DRAWINGS

AC: AC power
LAMP: Lamp
OUT: Switch output terminal
IN: Switch input terminal
1: Power supply circuit block
2: LCD driving circuit block
U₁: Control micom
TRC₁: Triac
R₁˜R₅: First˜fifth resistor
C₁˜C₄: First˜fourth capacitor
D₁˜D₃: First˜third diode
D₄˜D₅: Fourth˜fifth (Zener) diode
Q₁: First transistor
SW₁: Touch switch
V_{DD}: power terminal of DC power supply to the control micom
V_{SS}: Control micom grounding terminal
O₁: Output terminal for on/off control of the triac of the control micom
I₁: on/off switch Input terminal of control micom

### BEST MODE FOR CARRYING THE INVENTION

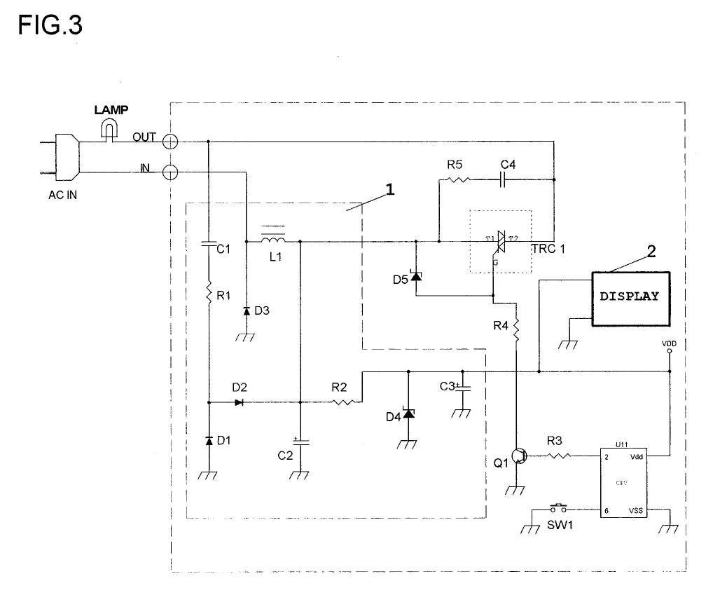

As explained above, the invented “power supply circuit for wall-mounted electronic switches” simplifies the structure of power supply circuit for multi-functional power supply switches demanding a high driving current, stabilizes the operation of power supply circuit, improves the space utility of switches, and price competitiveness. FIG. 3 shows some desirable application examples, but the invention is not limited to this example and can be modified in various ways without changing the scope of this invention, and such modifications are within the application scope of this invention.

1. A power supply circuit for wall-mounted electronic switches, comprising:
a coil connected to an in terminal,
a triac connected between the coil and an out terminal,
a capacitor of which one side is connected to the out terminal and of which another side is connected to a first resistor, one side of the first resistor being connected to the capacitor and another side being connected to a cathode of a first diode,
a second diode having an anode connected to the cathode of the first diode and a cathode connected to a connecting point of the coil and the triac, an anode of the first diode being connected to ground,
a second capacitor having a positive terminal connected to the cathode of the second diode and a negative terminal connected to ground,
a third diode having a cathode connected to the in terminal and an anode connected to ground, and
a second resistor having one side connected to the cathode of the second diode and another side connected to a cathode of a zener diode, the zener diode having an anode connected to ground, and which uses some amount of load current as a charging current for this power supply when the triac is in an on state.
